(19) United States
(12) Patent Application Publication
(10) Pub. No.: US 2007/0282618 A1
(43) Pub. Date: Dec. 6, 2007

(54) Method and system for scheduling delivery of at least one of goods and services

(75) Inventors: Francisco Barahona, White Plains, NY (US); Stephen John Buckley, White Plains, NY (US); Pawan Raghunath Chowdhary, Montrose, NY (US); John Joseph Forrest, Peekskill, NY (US); Tracy Jay Kimbrel, Cortlandt Manor, NY (US); Laszlo Ladanyi, Peekskill, NY (US); Baruch Menachem Schieber, White Plains, NY (US); Maxim Ivanovich Sviridenko, New York, NY (US); Grzegorz Michal Swirszcz, Ossining, NY (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 11/443,068

(22) Filed: May 31, 2006

(51) Int. Cl. G06Q 10/00; G06Q 30/00

(52) U.S. Cl. 705/1

(57) ABSTRACT

A method of scheduling delivery of at least one of goods (e.g., repair parts) and services (e.g., repair services) includes inputting a performance objective (e.g., a plurality of performance objectives), and network data pertaining to a network of mobile points, and generating (e.g., by utilizing the input network data and the performance objective) a delivery schedule for a delivery vehicle (e.g., one or more delivery vehicles) to deliver the at least one of the goods and services.

This invention was made with Government support under Contract No.: MDA972-01-C-0025 awarded by the Defense Advanced Research Projects Agency (DARPA). The Government has certain rights in this invention.

### BACKGROUND OF THE INVENTION

1. Field of the Invention

The present invention relates to the field of a method of scheduling delivery of at least one of goods and services, and more particularly, to a method which includes generating a delivery schedule for a delivery vehicle to deliver at least one of goods and services.

2. Description of the Related Art

Conventional systems for scheduling delivery of goods and/or services (e.g., delivery of at least one of goods and services) may work acceptably in noncomplex environments with fixed locations of inventory supply and demand. However, these systems fail to adequately schedule delivery of goods and/or services in a mobile network. For example, these conventional systems are typically unable to effectively schedule delivery in a complex environment in which the locations of goods (e.g., inventory supply) and/or services (e.g., a supply point) may vary and in which the locations of demands (e.g., a demand point) for those goods and/or services may vary.

For example, conventional systems utilized by military organizations may be able to schedule delivery of goods and/or services for peacetime garrison operations. However, such systems are typically not adequate, for example, when the military is engaged in a battlefield operation, where supply and demand locations for inventory (e.g., parts and supplies needed to conduct a battlefield operation) may vary and where effective scheduling of delivery of goods and/or services is especially important for efficiently conducting the operation.

### SUMMARY OF THE INVENTION

In view of the foregoing and other exemplary problems, drawbacks, and disadvantages of the conventional systems and methods, a purpose of the exemplary aspects of the present invention is to provide a method and system of scheduling delivery of at least one of goods and services which may effectively optimize a performance objective in a mobile network (e.g., an environment in which the locations of inventory supply and/or demand may vary).

In an exemplary aspect of the present invention a method of scheduling delivery of at least one of goods and services includes inputting a performance objective, and network data pertaining to a network of mobile points, and generating (e.g., by utilizing the input network data and the performance objective) a delivery schedule for a delivery vehicle (e.g., a plurality of delivery vehicles) to deliver the at least one of the goods and services.

In another exemplary aspect of the present invention, a system for scheduling delivery of at least one of goods and services includes an input device for inputting a performance objective, and network data pertaining to a network of mobile points, and a schedule generator for generating (e.g., by utilizing the input network data and the performance objective) a delivery schedule for a delivery vehicle to deliver the at least one of the goods and services.

Another exemplary aspect of the present invention includes a programmable storage medium tangibly embodying a program of machine-readable instructions executable by a digital processing apparatus to perform the method of scheduling delivery of at least one of goods and services according to the exemplary aspects of the present invention.

In another exemplary aspect of the present invention, the method of scheduling delivery according to the exemplary aspects of the present invention includes deploying computing infrastructure in which computer-readable code is integrated into a computing system, such that the code and the computing system combine to perform the inputting of a performance objective, and network data pertaining to the network of mobile points, and the generating of the delivery schedule for the delivery vehicle.

With its unique and novel features, the present invention provides a method and system of scheduling delivery of at least one of goods and services which may effectively optimize a performance objective in a mobile network (e.g., an environment in which the locations of inventory supply and/or demand may vary).

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1 illustrates a method 100 of scheduling delivery of at least one of goods (e.g., repair parts) and services (e.g., repair services), according to an exemplary aspect of the present invention;

FIG. 2 illustrates a system 200 for scheduling delivery of at least one of goods (e.g., repair parts) and services (e.g., repair services), according to another exemplary aspect of the present invention;

FIG. 3 illustrates an exemplary mobile network 300 which served as a basis for the experiments conducted by the inventors, to test network centric logistics (NCL) optimizers, according to an exemplary aspect of the present invention;

FIG. 4 illustrates an environment 400 which was used by the inventors in their experiments, and which may incorporate the method and system of delivering goods and/or services, according to an exemplary aspect of the present invention;

FIG. 5 provides a graph plotting the transform of the Percentage (p) of operational Strykers using transform function ƒ(p), according to an exemplary aspect of the present invention;

FIG. 6 illustrates an Integer Programming Algorithm 600 including the components, according to an exemplary aspect of the present invention;

FIG. 7 provides Tables 1 and 2 which illustrate some of the results of the experiments conducted by the inventors, according to an exemplary aspect of the present invention;

FIG. 8 illustrates a system 800 which has been developed and utilized by the inventors, according to an exemplary aspect of the present invention;

FIG. 9 illustrates a typical hardware configuration which may be used for implementing the system and method according to the exemplary aspects of the present invention; and

FIG. 10 illustrates a programmable storage medium 1000 tangibly embodying a program of machine-readable instructions executable by a digital processing apparatus to perform the method according to the exemplary aspects of the present invention.

### DETAILED DESCRIPTION OF EXEMPLARY EMBODIMENTS OF THE INVENTION

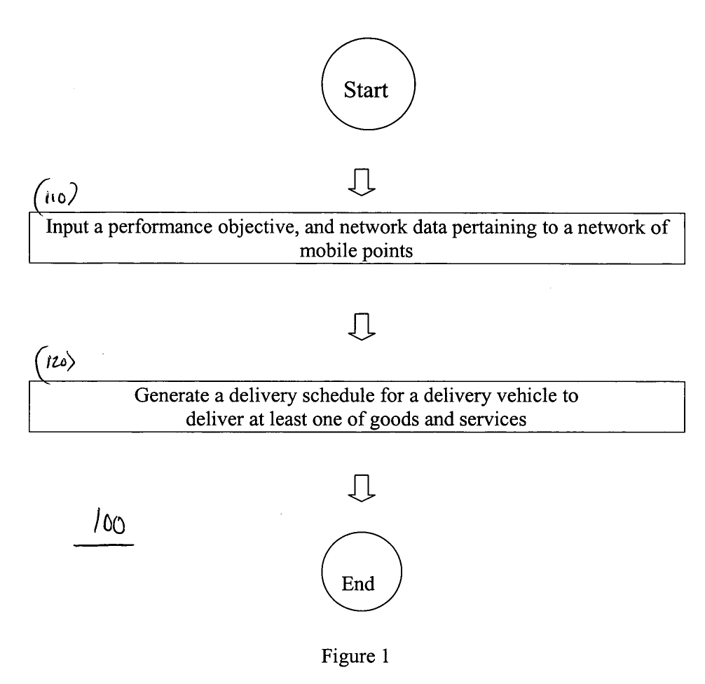

Referring now to the drawings, and more particularly to FIGS. 1A-6, there are shown exemplary embodiments of the method and structures of the present invention.

FIG. 1 illustrates a method 100 of scheduling delivery of at least one of goods (e.g., repair parts) and services (e.g., repair services) according to an exemplary aspect of the present invention. The method 100 includes inputting (110) a performance objective (e.g., a plurality of performance objectives), and network data pertaining to a network of mobile points, and generating (120) (e.g., by utilizing the input network data and the performance objective) a delivery schedule for a delivery vehicle (e.g., a plurality of delivery vehicles) to deliver at least one of the goods and services.

For example, the network data may include at least one of data pertaining to a plan of movements for the mobile points, data pertaining to the delivery vehicle and a list of services that the delivery vehicle can perform, a list of goods demanded by the mobile points, and a list of services demanded by the mobile points. Further, the mobile points may include at least one of a source point which is a source of the goods, a storage point for storing the goods, a service demand point which demands the services, and a demand point which demands the goods.

The services delivered by the delivery vehicle may include, for example, at least one of picking up parts, delivering parts, and carrying out repairs at a mobile demand point in the network of mobile points.

In addition, the network data may include at least one of a list of on-hand inventory for an item of the goods at a mobile point in the network of mobile points, a list of on-hand inventory for an item of the goods in the delivery vehicle, a list of demands for an item of the goods at a mobile point in the network of mobile points, and a list of demands for an item of the services at a mobile point in the network of mobile points.

Further, the performance objective may include at least one of immediate demand satisfaction, operational availability, customer wait time, off-the-shelf fill rate, and a target pre-positioned stocking level for an item of the goods.

In addition, generating the delivery schedule may include balancing immediate demand of an item of the goods with target pre-positioning levels of the item of the goods to optimize an enterprise objective.

The delivery schedule may include, for example, a policy for optimizing the performance objective. In addition, the goods may include at least one of service parts, production parts, and non-discrete parts.

A time allotted for the delivery may include a total time of non-negligible time-consuming activities required for the delivery before the delivery vehicle moves to a next demand point in the network. For example, where a delivery is made to repair a part on a vehicle, the time allotted for the delivery may include the time needed to repair the part.

Further, the delivery schedule may include a schedule for meeting an immediate demand for the goods and/or services and replenishing pre-positioned supplies of the goods at the mobile points. In addition, the network of mobile points may include a mobile demand point (e.g., a plurality of mobile demand points) having a variable location, and a mobile inventory stocking point (e.g., a plurality of inventory stocking points) having a variable location.

Further, generating the delivery schedule may include using one or both of an integer and linear programming algorithm and a local improvement algorithm. The method 100 may also include outputting the delivery schedule using at least one of a display device, audio device, and a printer.

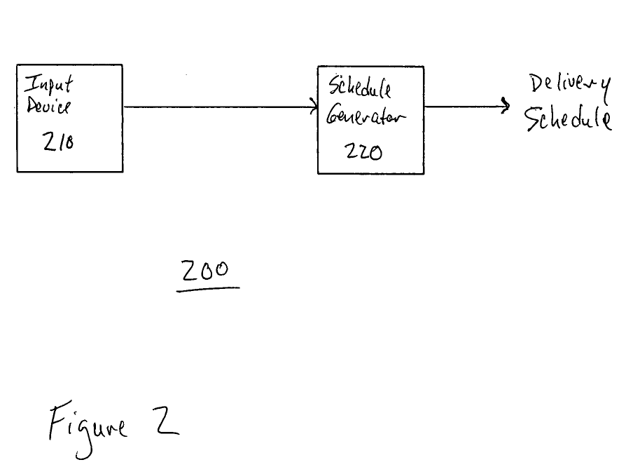

FIG. 2 illustrates a system 200 for scheduling delivery of at least one of goods and services including an input device 210 for inputting network data pertaining to a network of mobile points, and inputting a performance objective, and a schedule generator 220 for generating (e.g., by utilizing the input network data and the performance objective) a delivery schedule for a delivery vehicle to deliver the at least one of the goods and services.

The schedule generator may generate the delivery schedule by utilizing the input network data and the performance objective. The system 200 may also include an output device for outputting the delivery schedule.

### Overview

It should be noted that although the invention may be described at times in this Application as it may be used in a military logistics setting, this is merely an exemplary embodiment of the present invention. In no way should the present invention be considered limited to a military logistics setting but may be used to schedule delivery of goods and/or services in any mobile network (e.g., network of mobile supply and demand points).

For example, in another exemplary aspect of the present invention, the present invention may be used in performing disaster relief. Thus, the goods may include food and water, clothing, medical supplies, etc., and the services may include medical care, rescue operations, etc.

A purpose of an exemplary aspect of the present invention is to improve current logistics distribution systems, such as military logistics distribution systems which have been outpaced by the extreme maneuverability and changing demands of forces, resulting in low Operational Availability rates. A problem with conventional systems is that early deploying units may need pre-positioned levels of on-hand supplies.

The present invention may solve the problems of the current logistics distribution systems by creating a new family of tactical inventory management and distribution algorithms that are designed to work in a mobile environment. For example, the algorithms may work in the mobile environment of an operational military unit (e.g., a brigade), utilizing up-to-date information on available inventory, supply points, and demand forecasts, exploiting cross-leveling opportunities which might entail getting multiple parts from different, rapidly changing locations to complete a repair, accounting for unit movements within a planning (time) horizon, and deal effectively with temporal supply shortfalls (such as delayed deliveries) or more serious supply shortfalls that could lead to degradation of capability.

In particular, an exemplary aspect of the present invention may include a method of scheduling an inventory delivery action and/or a repair service action. In this exemplary aspect, the method may schedule delivery and/or service in a logistics network with mobile supply and demand points.

For example, in an exemplary aspect of the present invention, the method may include finding an inventory delivery and repair service scheduling policy for supply parts in a mobile logistics network that optimizes one or more performance metrics. The term “supply parts” may include service parts, production parts, or non-discrete parts (fuel, water) (e.g., a part type may be crew-replaceable or require a service vehicle to stay during repair). Further, the “delivery” may entail repair or other time-consuming activities (such as non-negligible unloading time) before moving on to another demand point. Performance metrics optimized in the method may include operational availability, customer wait time, and target pre-positioned stocking levels.

Further, in an exemplary aspect, the method may efficiently schedule the service of immediate demands and replenishment of pre-positioned supplies at logistics points. The method may also deal with mobile demand points and inventory stocking points that may change their actual positions within the planning horizon.

The method may include as inputs data pertaining to a logistics network (e.g., a list of supply part types; a list of logistics points and their positions (e.g., supply and demand points, where demand may include immediate and pre-positioning, etc.); relative importance or priority of a logistics point (e.g., each logistics point) by time period; and a list of transportation vehicles and their positions), data pertaining to movement plan (e.g., expected location of a logistics point (e.g., each logistics point) by time period; expected transit time between two or more logistics points by time period), data pertaining to capacities (e.g., storage capacity of a service part type (e.g., each service part type) at a logistics point (e.g., each logistics point) by time period), data pertaining to inventory state (e.g., expected delivery times of parts supplied externally; current on-hand inventory at each logistics point; current in-transit inventory), and data pertaining to demands (e.g., current open orders (unfilled immediate demand); target pre-positioning levels by time period).

The method may output, for example, an optimized schedule for one or more vehicles (e.g., delivery/repair vehicles) with respect to a particular objective function. The schedule may specify, for example, vehicle movements, type and quantity of parts to load at a stop (e.g., each stop), type and quantity of parts to unload at a stop (e.g., each stop), and other actions that need to be carried out (such as repairs) at a stop (e.g., each stop).

Further, the method may employ various algorithms, such as an integer and linear programming algorithm, a local improvement algorithm, etc.

### Detailed Discussion

In an exemplary aspect of the present invention, a method of scheduling delivery of goods and/or services (e.g., at least one of goods and services) may generate a delivery schedule by employing a Transportation Scheduling Optimizer that may be used (e.g., along with an Inventory Optimizer) for Network Centric Logistics (NCL). A purpose of NCL may include collecting, disseminating, and reacting to real-time information to improve scheduling of inventory transportation.

In the logistics domain this may translate to real-time information on the status of available parts inventory, the current locations of mobile supply points, and an up-to-date picture of the demand for parts. With real-time information available, optimized and flexible inventory and delivery plans which may decrease replenishment times may be generated. An exemplary aspect of the present invention may include a logistics algorithm which may be used to achieve this purpose, based on state-of-the-art mathematical optimization models.

To evaluate the present invention, the inventors conducted a series of experiments in which the inventor's optimization models were driven by a Simulation Experimentation testbed which may take an Operations Plan (OPLAN) and generate detailed time-phased force deployment data.

In these experiments, the demonstration was driven by a battlefield scenario of 30 days. The optimization models were asked to produce a plan for the storage and delivery of Class IX supplies for a Stryker brigade (Class IX pertains to: repair parts and components, including kits and assemblies for maintenance support (e.g. batteries, spark plugs, and axles)).

It should be noted that the Stryker is the combat vehicle of choice for the Army's Interim Brigade Combat Teams (IBCTs). It is a highly deployable-wheeled armored vehicle that combines firepower, battlefield mobility, survivability and versatility, with reduced logistics requirements. The Stryker-equipped IBCT will provide the joint and multinational force commander increased operational and tactical flexibility to execute the fast-paced, distributed, non-contiguous operations envisioned across the full spectrum of conflict (e.g., see army.milfeaturesstrykerdefault.htm).

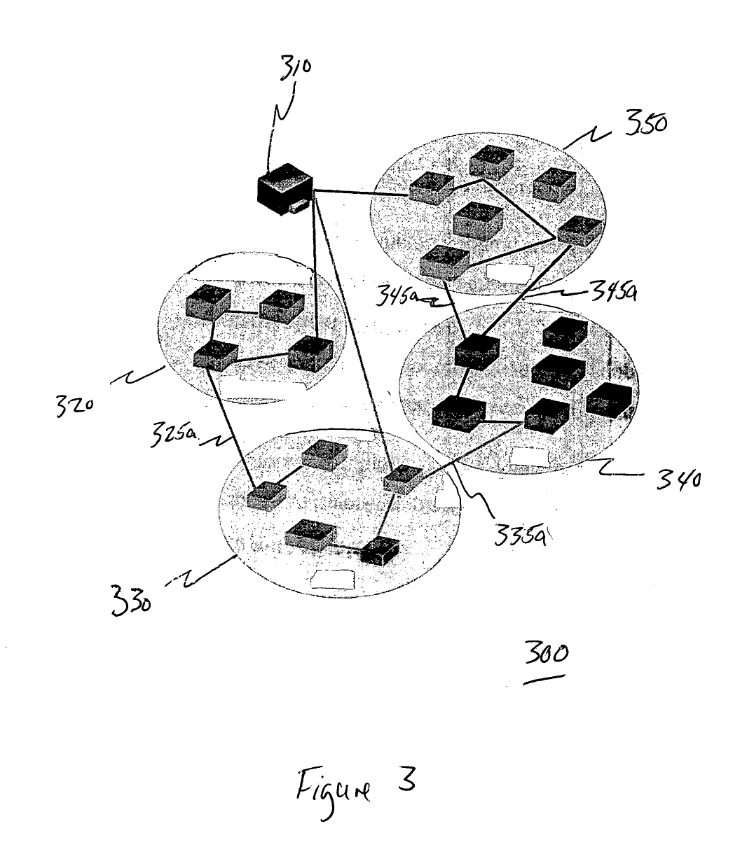

FIG. 3 illustrates an exemplary mobile network 300 which served as a basis for the experiments conducted by the inventors, to test network centric logistics (NCL) optimizers, according to an exemplary aspect of the present invention. As illustrated in FIG. 3, in the network 300, inventory (e.g., Class IX inventory) may be distributed between the Brigade Support Battalion (BSB) 310 and combat battalions (e.g., a 4 days supply may be maintained at BSB, and a 3 days supply may be maintained at the combat battalion), supply trucks may be shared between combat battalions and the cavalry squadraon, combat battalions and the cavalry squadraon, combat may advise BSB of exact quantities of inventory (e.g., Class IX supply) required based on current breakages, prestock supply quantities may be determined automatically by an Inventory Optimizer, supply truck schedules may be continually optimized to re-supply the infantry companies, cross-leveling may be performed automatically by a Transportation Optimizer.

In this exemplary mobile network 300 there may be a pre-positioning of supply at the cavalry squadron 320, and battalions 330, 340 and 350. Further, the lines 325a, 335a, and 345a illustrate the cross-leveling of inventory between the cavalry squadron and first battalion, between first and second battalions and between second and third battalions, respectively.

An inventory optimizer may produce an inventory plan over a time period. For example, in the network 300 in FIG. 3, an Inventory Optimizer may produce an inventory plan for units (e.g., all units) in a brigade over a next 72 hours. The inventory optimizer may also use profiles of future inventory, future expected breakages, and future expected positions of logistics points. The inventory optimizer may also respect storage capacities and consider the relative importance (e.g., per OPLAN) of units, and realize opportunities for cross-leveling of supply between units.

In the network 300, a Transportation Optimizer may produce a transportation schedule for all Combat Repair Teams (CRTs) in the brigade for the next 72 hours, the CRTs load parts at the appropriate supply points (BSB or companies) and deliver parts to Strykers that need repair. The CRTs may also visit companies to redistribute parts so that companies approach inventory levels determined by the Inventory Optimizer.

The use of the inventory and transportation optimizers in the network 300 of FIG. 3 may help to provide for continual optimization (e.g., the term “continual optimization” may refer to re-optimizing at any frequency). Both optimizers may re-optimize at fine granularity. The 72-hour horizon may be used to find the best plan, assuming nothing changes, at each time increment (which can be as small as 1 hour) (it should be noted that one hour is the granularity in the experimental simulations conducted by the inventors, but this is only exemplary and any granularity may be used). The initial portion of this plan may be executed, and at the next increment, a new plan may be derived using any new data that has become available.

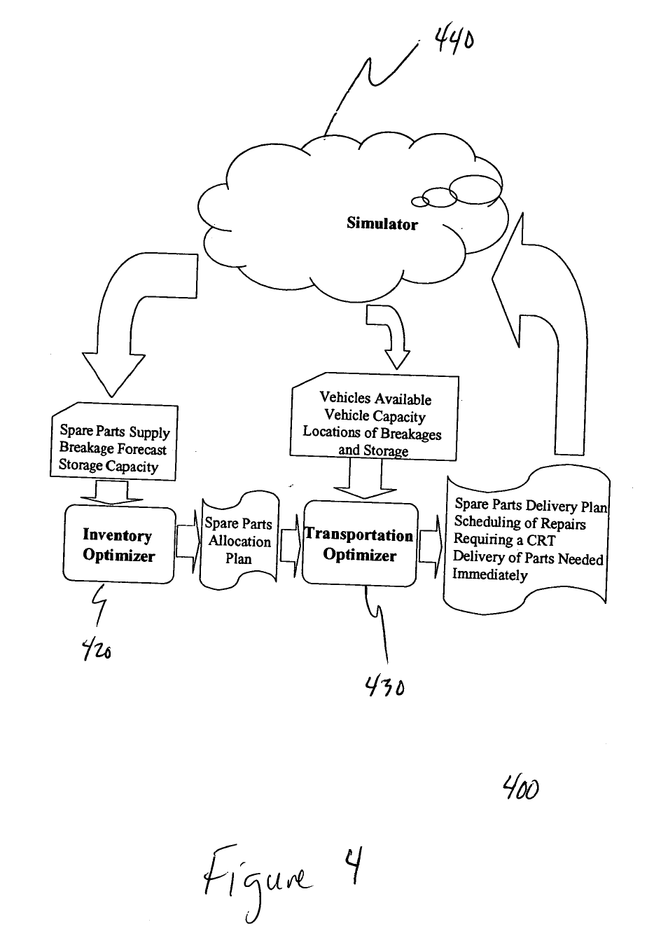

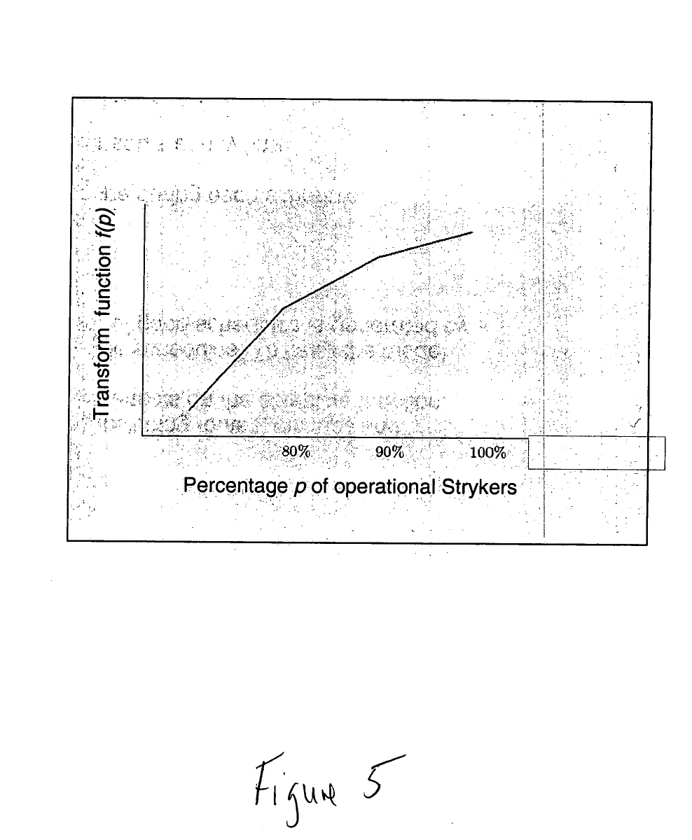

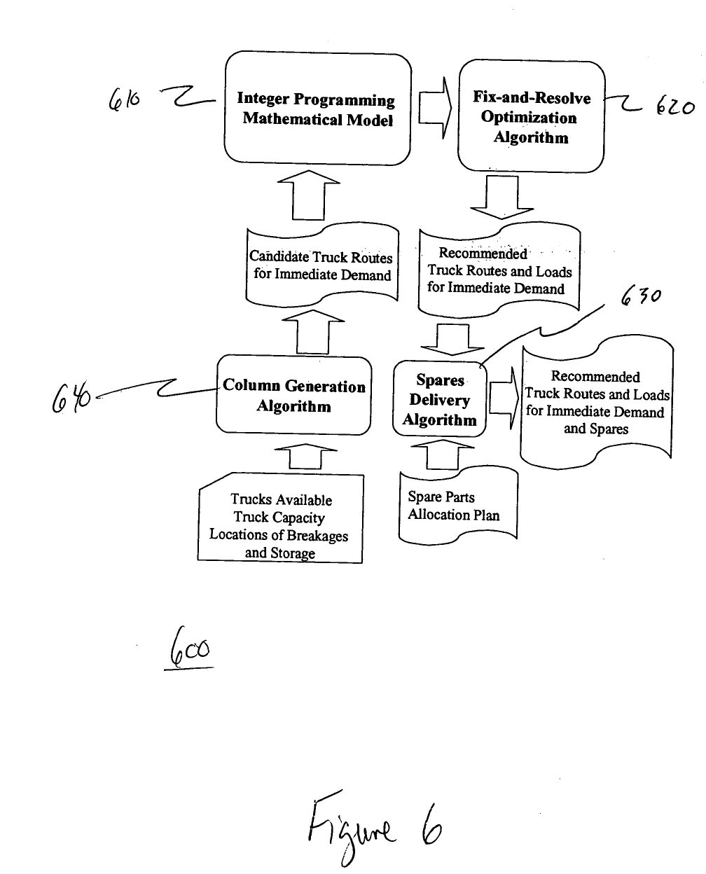

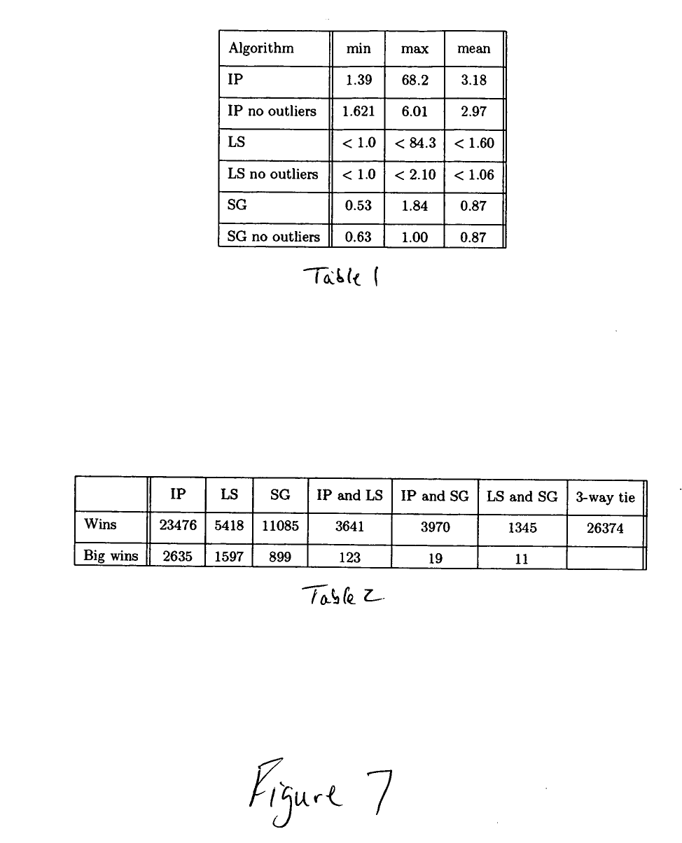

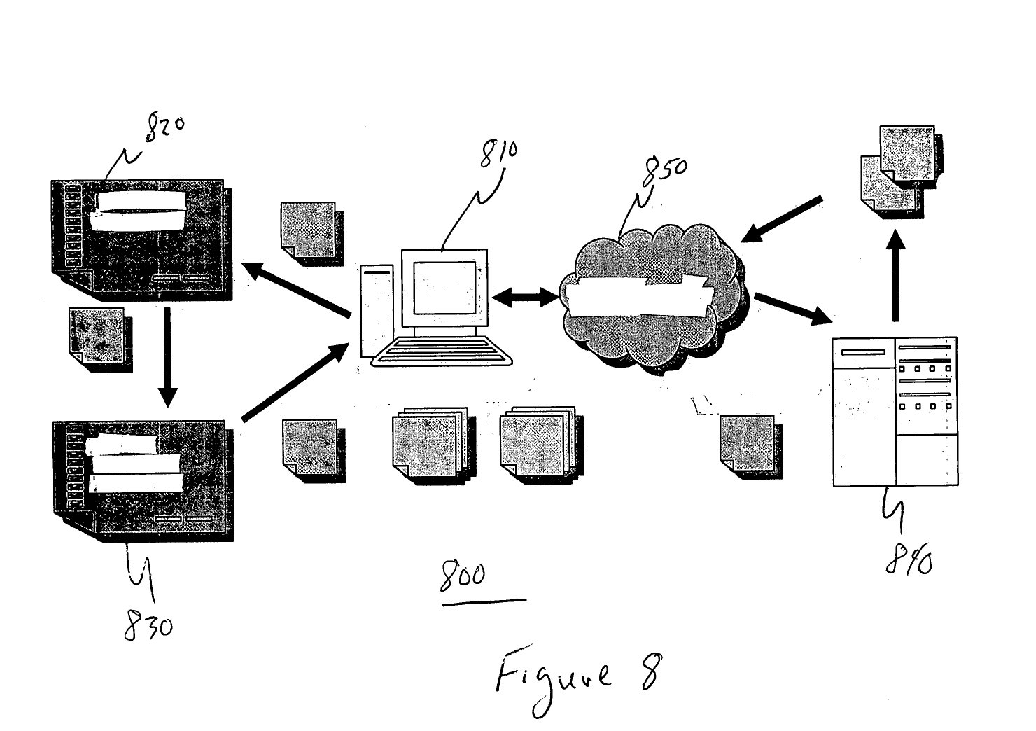

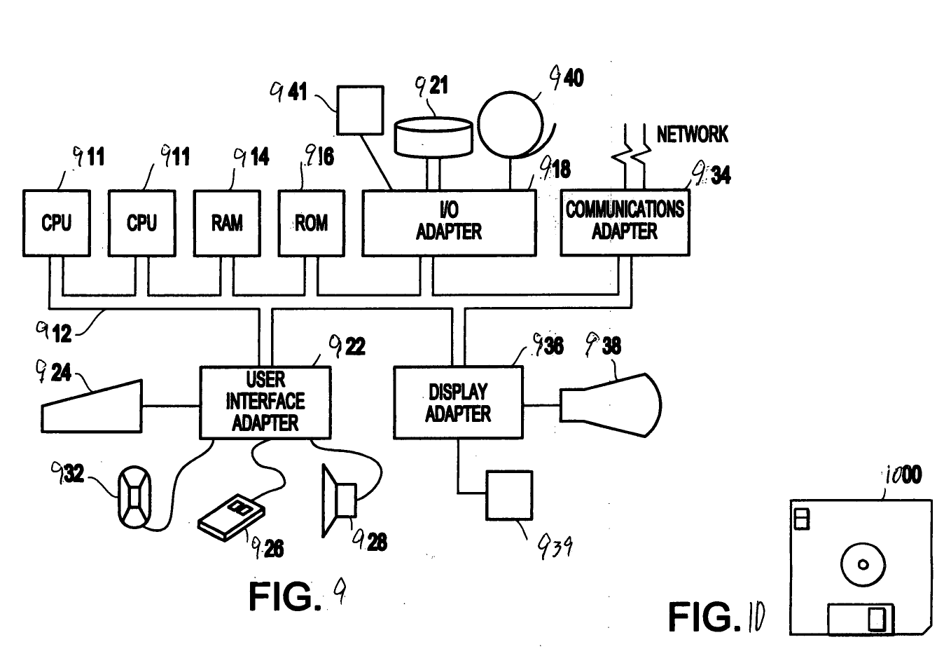

Referring again to the drawings, FIG. 4 illustrates an environment 400 which was used by the inventors in their experiments, and which may incorporate the method and system of delivering goods and/or services according to an exemplary aspect of the present invention. That is, the environment 400 includes a Transportation Optimizer 430 which may have a function and design which is similar to the schedule generator 220 in the system 200. That is, the Transportation Optimizer 430 may be used to generate (e.g., by utilizing the input network data and the performance objective) a delivery schedule for a delivery vehicle to deliver at least one of goods and services according to an exemplary aspect of the present invention.

FIG. 4 illustrates a high-level view of the components, their inputs and outputs, and the flow of information among them and the simulator 440, in the environment 400. For ease of exposition, the portion of the environment 400 which includes the Inventory Optimizer 420 and Transportation Optimizer 430 may be referred to simply as “the optimizer.”

As illustrated in FIG. 4, the Inventory Optimizer 420 may take as input a forecast of available goods (e.g., inventory), a forecast of breakages (e.g., Stryker breakages), and the future positions of the mobile points (e.g., logistics points). The Inventory optimizer 420 may produce as output an inventory plan for stocking levels of goods at some or all points in the network for a predetermined time period (e.g., distributing and moving spare parts among the Brigade Support Battalion (BSB) and each company in the brigade for the next 72 hours).

In determining the goods (e.g., parts) allocations and inventory level in the mobile network, the Optimizer 420 may consider the restrictions on storage capacity at all echelons of the hierarchy as well as the relative priorities of points in the network (e.g., the combat units), as specified in the scenario data. The Optimizer 720 may also realize opportunities for cross-leveling of supply between points (e.g., companies) (it should be noted that “cross-leveling” may refer to moving supplies between demand points as well as the traditional method in which supplies are distributed strictly hierarchically through a hierarchy of supply points).

The Transportation Optimizer 430 may use as input the current data locations of demand points (e.g., locations of broken Strykers) and the inventory plan that the Inventory Optimizer 420 generates. The Optimizer 430 may produce a plan for delivering goods and/or services (e.g., a schedule for delivering parts and carrying out repairs for the vehicles of the CRTs. This plan or schedule may include the goods (e.g., spare parts) to carry on a delivery vehicle (e.g., each vehicle) and the locations at which to load and unload the goods. In some cases the unloading of goods may be performed along with delivering a service (e.g., delivering a part at a broken Stryker may entail carrying out a repair that cannot be carried out by the Stryker's crew).

In the exemplary mobile network 300, an important (e.g., primary) objective is to deliver the spare parts needed to repair broken Strykers. Another (e.g., secondary) objective is to replenish the parts inventory at the logistics points to approach the levels specified by the Inventory Optimizer. This may allow repairs to begin immediately upon breakage (if the part is available in the same company) or very soon thereafter (if the part is available in the same battalion) in the case of crew replaceable parts that are carried on-board.

Battalions are made up of smaller units called companies. Thus, for example, if a part is stocked within the company containing the broken Stryker, the part may be immediately available. If it is in another company in the same battalion, it may take some time for the part to become available, but probably less time than if the part is delivered by a CRT.

In a time increment (e.g., each time increment) of a scenario run, the optimizer 430 may get the current state from the simulator 440 and compute an optimized delivery plan covering the next 72 hours. However, the optimizer 430 may send to the simulator 440 only the initial portion of this plan corresponding to the time increment. This may be typically about 3 hours, but experiments have been conducted with higher and lower frequencies.

(It should be noted that the values 72 hours and 3 hours were chosen somewhat arbitrarily. In a full-scale development effort, these parameters may likely be tuned. In the inventor's experiments, these and other parameters have been given reasonable values via judgment from experience and first principles.)

The simulator 440 may commit and execute the initial portion of the schedule transmitted to it by the optimizer 430. As the simulated scenario evolves, the OPLAN may change. For example, new Strykers may break down, new spare parts may become available, and the locations of the supply and demand points may change. The simulator 740 may communicate these changes to the optimizer, which produces, a new solution optimized for the new state, and so on.

This may be described as “Continual Optimization”. That is, the solution may be continually updated in response to changing conditions. In principle, the optimization frequency can be made arbitrarily high. Alternatively, re-optimization can be triggered by a change (e.g., every change) in the data.

A schedule covering a longer time period than the period over which it will actually be used, may be computed. There are two reasons for this. First, it may be possible to reuse the remaining portion of the schedule with few modifications, or as a starting point for a new round of optimization in response to new data.

Second, and more important, in order to evaluate the quality of the initial portion of the schedule (e.g., the short-term part that will be committed in the current iteration) it should be determined how the portion affects performance in the long term. A short-term schedule that achieves good immediate results may be inferior to one that produces better results in the longer term. In their experiments, the inventors did not attempt to reuse the previous iteration's schedule. Instead, the inventors found a new solution from scratch on each iteration.

Referring again to FIG. 4, a purpose of the Inventory Optimizer 420 is to determine the correct pre-positioned levels of goods in the network (e.g., the levels of repair part supplies in the theater), to ensure that the mission capability of a brigade is close to optimal. For this purpose, the inventors developed a novel operational inventory allocation model. The model utilizes up-to-date information on available inventory, supply points, and demand forecasts.

The model may exploit cross-leveling opportunities, which might entail getting multiple parts from different, rapidly changing locations to complete a repair. The model may account for movements of mobile points (e.g., military units within the brigade), and may deal with temporal supply shortfalls (such as delayed deliveries) or more serious supply shortfalls that could lead to longer-term degradation of capability.

In an exemplary aspect of the present invention, the Inventory Optimizer 420 and the Transportation Optimizer 430 may share the same ultimate objective: improve the distribution and delivery of goods and/or services (e.g., optimize in-theater distribution and delivery of repair parts within a brigade) to approach the best possible mission capability. A standard performance metric of mission capability is Operational Availability, Aₒ.

For example, in the Stryker brigade of the exemplary mobile network 300, Operational Availability may be defined as the fraction of mission-capable Strykers out of the total number of Strykers in the brigade. For example, if a battalion comprises 60 Strykers and 3 Strykers are waiting for repair parts or are undergoing repair, the Operational Availability is Aₒ=57/60=95. In military practice, Aₒ is measured separately for different classes of vehicles and units, and may take into account priorities, before it is rolled up to Operational Availability at the battalion and brigade level.

### The Transportation Optimizer

The present invention may provide a solution approach for generating a delivery schedule for delivery of at least one of goods and services (e.g., generating an optimized plan for the vehicles that load and deliver spare parts). For example, in the exemplary mobile network 300, an important goal is to determine a schedule for the repair vehicles (CRTs) to load parts at the supply locations (BSB and companies) and deliver them to the Strykers that need repair. The CRTs' schedules may also be given load and unload operations for parts that are not needed immediately so that the inventory level at each location approaches the target specified by the Inventory Optimizer (an Inventory Optimizer such as that described, for example, by Ettl et al., SYSTEMS AND METHODS FOR INVENTORY ALLOCATION IN MOBILE LOGISTICS NETWORKS, docket no. YOR920050561US1, U.S. patent application Ser. No. 11,347,200, which is commonly assigned herewith and incorporated herein by reference).

Referring again to FIG. 4, in the environment 400, one of the inputs to the Transportation Optimizer 430 (e.g., schedule generator) may include the output of the Inventory Optimizer 420 which may include, for example, a list of which parts need to be delivered to which locations and at what times to achieve optimized pre-placement of inventories.

Other inputs to the Transportation Optimizer 430 may describe the number of available vehicles and their operational constraints, such as their ranges of operation and their capacities for storing parts. An exemplary aspect of the present invention may incorporate a variety of other operational constraints, such as: durations of time windows during which load and delivery operations are allowed, preferred or prohibited assignments of vehicles to routes, and constraints on the total length and composition of a route (such as limits on the number and types of deliveries in each route). Such constraints may help create an overall delivery plan that is operationally robust and that can be executed with greater success rate in the ever-changing conditions in the theatre (it should be noted that in the inventor's experiments using the exemplary mobile network 300, only the truck capacities and delivery time windows were used as inputs to the Transportation Optimizer 430).

For available vehicles (e.g., each available vehicle) an exemplary aspect of the present invention may either produce a route or label the vehicle as idle. A route may be described by the following.
The locations to visit (e.g., BSB, company or broken Stryker) in sequential time order. A route may include companies and broken Strykers that belong to more than one battalion (in contrast to the traditional hierachical assignment of CRTs). A route may start at the current location of the vehicle, and may end at either the BSB, a company or a broken Stryker. The time length of a tour will not exceed the planning horizon, i.e., the next 72 hours.
The sequence of operations to perform at each location (e.g., load part, unload part, or repair broken Stryker).

### Objective Function

The objective function used by the schedule generator (e.g., Transportation Optimizer 420) may include two terms. The first term may measure availability (e.g., the availability of Strykers) over the planning horizon. The objective function may also include a “penalty” term reflecting a set of “orders” of priority lower than delivering parts and services required immediately (e.g., repairing broken Strykers). The penalty term may correspond to the desired placement of goods (e.g., parts) as computed by the Inventory Optimizer 420. These orders may be considered satisfied when the inventory at the various locations meets or exceeds the levels recommended by the Inventory Optimizer. Otherwise these orders may be considered unsatisfied, to a degree captured by the corresponding penalty term.

A good schedule may prioritize the delivery of services (e.g., prioritize repairs as to maximize the number of operational Strykers across battalions and time, taking into account the relative weight of each battalion b at each time period t, w_{b,t}, and striving to balance the availabilities of battalions). To achieve this goal, the objective function may include a term ƒ_{b,r}(r_{b,t}) that measures operational availability (e.g., operational availability of Strykers at battalion b and time t as a result of the repairs). The objective function may be the sum of these availabilities (e.g., weighted over all battalions and time periods):

$$maximize {\sum }_{b , t} {w}_{b , t} {f}_{b , t} ( {r}_{b , t} ) \qquad ( 1 )$$

For example, three ranges of operational availability may be defined for the Strykers: up to 80, from 80 to 90, and from 90 to 100. Each one has a distinct priority. The terms ƒ_{b,t}(r_{b,t}) may be created in the objective function in a way that captures these three levels of priority.

For example, let V_{b} be the total number of Strykers in battalion b, and let N_{b} be the number of operational Strykers at time period 0. Recall that the variable r_{b,t} denotes the number of Strykers in battalion b that have been fixed before or during period t. Thus, the fraction of operational Strykers at period t in the battalion is given by (r_{b,t}+N_{b})/V_{b}.

A first priority in repairing is to get this fraction up to about 0.8. Another (e.g., secondary) priority is to get this fraction to the next 10% (e.g., up to about 0.9), and another (e.g., tertiary) priority is to be fully operational (e.g., have the fraction at 1.0). In the objective function, these levels of priorities may be given weights that reflect their relative importance (e.g., 4, 2 and 1, respectively). With these weights each term ƒ_{b,t}(r_{b,t}) may be a piecewise linear concave function, as shown in FIG. 5 which provides a graph plotting the transform of the Percentage (p) of operational Strykers using transform function ƒ(p)).

The composite function including the weighted measure of availability and the terms corresponding to pre-placement may be given as:

$${\sum }_{b , t} {w}_{b , t} {f}_{b , t} ( {r}_{b , t} ) - α \frac{1}{PCT} {\sum }_{p , c , t \leq T \text{:} {R}_{p , c , t} < {R}_{p , c , t}^{*}} ( 1 - \frac{{R}_{p , c , t}}{{R}_{p , c , t}^{*}} ) \qquad ( 2 )$$

where
w_{b,t} is the weight corresponding to the priority of battalion b at time t;
ƒ_{b,t}(r_{b,t}) measures the weighted operational availability of Strykers as a result of repairs at battalion b and time t. It is defined in equations (10) and (11) below.
α is an influence factor between 0 and 1;
P is the number of parts p;
C is the number of companies;
T is the number of time periods in the planning horizon. For example, in an exemplary aspect of the invention, T=72;
R_{c,p,t} is the actual cumulative receipts by time t for partp at company c. It is computed as follows:

$${R}_{c , p , t} = \begin{matrix}{\sum }_{i \leq t} quantity of p unloaded at time i at c - \\ {\sum }_{i \leq t} quantity of p loaded at time i at c\end{matrix} \qquad ( 3 )$$

The unload and load operations may come from the current truck plan, as generated by one of the three scheduling optimization algorithms. The parts count may includes parts loaded or unloaded to fix broken Strykers; and
R*_{c,p,t} is the optimized cumulative receipts by time t for part p at company c as generated by the Inventory Optimizer (e.g., the target value).

Thus, the objective function may add a penalty for each under-fulfillment case (e.g., each combination of p, c and t where the actual cumulative receipts fall below the optimized ones. (When the actual receipts equal the optimized ones, the penalty may be zero). The penalty may be scaled by the product PCT, which is the maximum number of under-fulfillment cases possible. Thus the penalty term in the objective function may assume values between zero and one.

The influence factor α may determine the relative influences of the two parts of the objective. In this exemplary aspect of the present invention, a value of 0.05 was used, which provided good results.

The present invention may use one or more different approaches to produce optimized vehicle schedules. For example, in an exemplary aspect, three approaches may be recommended for producing optimized vehicle schedules: Integer Programming, Local Search and a heuristic called “Sophisticated Greedy”. The present invention may combine these algorithms into a Continual Optimization solution.

In the Integer Programming approach, routes may be first produced for the trucks to deliver parts to Strykers that need repair. Then the trucks may be reused on these routes to deliver to the companies the spare parts specified by the Inventory Optimizer. The Local Search approach may work to satisfy both goals concurrently.

### Finding Shortest (e.g., Fastest) Routes

In the present invention, the scheduling algorithms (e.g., described below) may include (e.g., require) a means to find the shortest route, in terms of travel time, to a moving “target” (i.e., a demand point or storage point). A variant of a well-known procedure known as Dijkstra's algorithm may be used. This algorithm, and the novel modifications made by the inventors are described below.

Dijkstra's algorithm finds the shortest route from an origin point to each of a set of possible destination points in the network. It does this by maintaining a set of “marked” points, for which a shortest route is known with certainty (where “short” may be in terms of distance, time, or some other measure; in the case of the present invention, time may be the measure of interest). Initially, this set contains only the origin. Points are added to this set one at a time until it contains all points. At all times, each marked point can be reached by a route that passes only through marked points, and this route is no longer than any other route (including ones that may contain unmarked points).

At each step, a new point to be marked is chosen as follows. Each unmarked point that can be reached by a route through only marked points and then directly via a single link from a marked point is considered as a candidate. A candidate point that is reached by a shortest such route is selected, and the route to the point and its time are recorded.

The present invention may include an enhancement of Dijkstra's algorithm. In the present invention, a road map may be provided in the form of a directed weighted graph, in which the weight of each edge represents the travel time across the edge. The speed of travel along the edge is assumed to be uniform, but might depend on the time of the start of the travel.

Given an initial location and a start time, and the route of a target (list of nodes visited by the target and departure and arrival times for each node), it may be desired to find an optimal route in order to meet the moving target. Note that the optimal route might require meeting the target on a road segment between the nodes.

The algorithm in the present invention may include the following:

1. Construct a set N of nodes visited by the target.

2 The classical Dijkstra algorithm is for graphs in which the weights (travel times) are constant (i.e., not dependent on time). The present invention recognizes, however, that the procedure can be generalized to the case in which travel times are time-dependent (for instance, in case it is safer to travel at a higher speed during daylight hours than at night). While building a set of marked nodes the arrival time at each node may be known. Therefore, when searching for the next node to be added travel times from each of the marked nodes can be calculated, substituting the arrival time at each of the marked nodes as the time of the beginning of the trip.

3. As the outcome of step 2, the present invention calculated for each node in N the time tₛ of the earliest possible arrival at this node, starting from the initial location. For each of those nodes, the times tₜ of arrival and Tₜ of departure of the target from the node may be known.

The present invention iterates through the nodes in N ordered by the departure times (observe that the same node can be visited by the target many times) until the present invention finds the first node N₁ for which tₛ<Tₜ. In case tₛ>tₜ this is the location at which the target may be met. In case tₛ<tₜ, it may be desired to catch the target between N₁ and the previous node N₀ visited by the target. This may require calculating the time to travel to N₁ and then meeting the target on the road from N₁ to N₀, and also calculating the time to travel to N₀ and then meeting the target on the road from N₀ to N₁ (note that in an exemplary model these two roads are different edges of the directed graph, connecting the same pair of nodes). The smaller of the two times determined may be chosen, and the meeting location is the location corresponding to this chosen time.

### The Integer Programming Algorithm

The Integer Programming algorithm may optimize the first term of the objective function directly using Integer Programming. That is, the algorithm may first seek only to deliver goods and services (e.g., fix broken Strykers), and ignore inventory placement. The algorithm may then heuristically add scheduling operations attempting to satisfy the recommended inventory placement produced by the Inventory Optimizer 420.

FIG. 6 illustrates an Integer Programming Algorithm 600 including the components (e.g., Integer Programming Mathematical Model 610, Fix-and-Resolve Optimization Algorithm 620, Spares Delivery Algorithm 630, and Column Generation Algorithm) of the algorithm 600.

To meet an important objective (e.g., repairing Strykers), the inventors created and solved an Integer Programming Mathematical Model 610. This model may use, for example, Column Generation, a sophisticated technique to generate possible routes for each vehicle. The inventors also use a specialized technique called Fix and Resolve to solve the Integer Program and determine optimized routes for the vehicles. Note that the vehicles on these routes may be reused to transport the rest of the inventory to the companies.

### The Integer Programming Mathematical Model

An Integer Programming mathematical problem is similar to a Linear Programming problem, with the additional restriction that some of the variables can only take integer values. A Linear Programming problem is a mathematical problem of the following type: one seeks to assign values to numerical variables, so that the values satisfy a collection of linear equalities and inequalities (the constraints) and also maximize a linear function (the objective function). The objective function is expressed as a weighted sum of the values of the variables. Linear and Integer Programming models have been in wide use since WWII both in military and industrial Operations Research, to solve a variety of problems in vehicle and personnel scheduling, facility location, portfolio selection, distribution network planning and other practical applications.

### The Variables

Exemplary variables may include the following:

For each route j that a vehicle can be assigned to, a variable xⱼ may be defined. This is a binary variable. That is, the variable takes only one of two integer values: 1, if the route j is used in the schedule, (a vehicle travels the route), and 0 otherwise:

xⱼε{0,1} for all routes j (4)

The number of possible routes may be very large; if all of the possible routes were to be included them all, the result may be an unmanageable model with far too many variables xⱼ. To generate just the routes and variables needed, a heuristic technique called Column Generation may be employed. The variable r_{b,t} may be defined as the number of Strykers in battalion b that have been fixed before or during period t. This should be a non-negative number. That is:

r_{b,t}≧0 for each battalion b and each period t. (5)

This variable should also take only integer values. However, this does not need to explicitly declared, and a computational benefit may be realized as a consequence: by virtue of a constraint (discussed below), declaring xⱼ integer suffices to have r_{b,t} be integer as well.

### The Constraints

Exemplary constraints may include the following:

1) A broken Stryker should be visited at most once during each schedule. To express this, let S(i) be the set of routes that include a stop at a broken Stryker i. Then,

$${\sum }_{j ∈ S ( i )} {x}_{j} \leq 1 for each broken Stryker i \qquad ( 6 )$$

2) Each available vehicle will either be assigned to exactly one route or will sit idle. To express this, let T(v) be the set of routes that vehicle v can be assigned to. Then

$${\sum }_{j ∈ T ( v )} {x}_{j} \leq 1 for each vehicle v \qquad ( 7 )$$

Two or more vehicles can be candidates for the same route or for a portion of the same route. To keep track of such possible assignments, we label each combination pair of candidate route and vehicle; the pair is then unique.

3) The quantity of a part transported away from a location on vehicles visiting the location should not exceed the quantity available at the location. To model this, let P(k,t,l) be the set of routes on which the assigned vehicles transport away part k from location l up to and including time period t. Let d_{k,j,l} be the quantity of part k that the vehicle on route j transports away from location l. Let n_{k,t,l} be the quantity of part k available at location l up to and including period t. Then the constraint reads:

$${\sum }_{j ∈ P ( k , t , l )} {d}_{k , j , l} {x}_{j} \leq {n}_{k , t , l} for each part k , \\ for each period t and each location 1 \qquad ( 8 )$$

4) The number of Strykers serviced by the vehicles on the routes equals the number of Strykers repaired. Let U(b,t) be the set of routes for vehicles that visit a broken Stryker in battalion b before or during period t. Let a_{b,j,t} be the number of Strykers in battalion b that the vehicle on route j services up to and including period t. This is an integer non-negative constant. Thus,

$${\sum }_{j ∈ I ( b , t )} {a}_{b , j , t} {x}_{j} = {r}_{b , t} for each battalion b and each period t \qquad ( 9 )$$

To capture the function ƒ_{b,t}(r_{b,t}) in the objective function (Equation (2)), three variables are introduced, y1, y2 and y3: y1measures the extent to which 80 of the Strykers are operational; y2measures the next 10, and y3measures the final 10. Their sum must be the actual operating fraction, and we include a constraint to capture that.

Thus, each term f_{b,t}(r_{b,t}) in the objective function is

f_{b,t}(r_{b,t})=4 y₁+2y₂+y₃ (10)

and the additional variables and constraints needed to represent it are defined by

y₁+y₂+y₃=(r_{b,t}+N_{b})/V_{b}

0≦y₁≦0.8

0≦y₂≦0.1

0≦y₃≦0.1 (11)

### Column Generation for Vehicle Routes

In Integer Programming models for scheduling delivery (e.g., scheduling vehicles) there are usually too many routes to consider explicitly. However, an optimal schedule produced by Integer Programming optimization may contain relatively few routes (which may not be known in advance).

Column generation is a family of heuristic methods that may be used to produce good candidate routes (e.g., routes that drive the optimization forward and have the potential of being part of an optimal schedule).

Each possible route corresponds to a variable in the mathematical model. For each variable a column in the matrix of the mathematical model formulation describes how the variable participates in the constraints. Each row corresponds to a constraint. The entry at each row of the column is the coefficient multiplying the variable in the corresponding constraint. Thus, Column Generation actually creates and adds to the mathematical model a column for every route being generated.

The ability to generate good columns quickly is the make-or-break test of an Integer Programming approach. Consequently, successful heuristics are quite sophisticated, as they involve both deep mathematics and an intimate knowledge of the scheduling problem.

Several tested methods exist for generating good routes, including the Closest Neighbor, Clark-Wright, Cluster-and-Route Algorithms, which are described below.

### The Closest Neighbor Algorithm

For a given vehicle, a Stryker may be selected at random from among the k broken ones that are closest to the current location of the vehicle. This Stryker may be added as the next stop to the route of the vehicle.

Then, from this Stryker's location the algorithm looks for another broken Stryker among the k closest ones to visit next. This process may be repeated until no more broken Strykers can be fixed with the spare parts that the vehicle carries. The next stop on the route is then the BSB, where the vehicle goes to load new spare parts. Then, the algorithm looks again for a broken Stryker among the k closest ones as before. The algorithm keeps adding stops to the route in this fashion, until the vehicle on the route has visited all broken Strykers or the route lasts longer than the 72 hour planning horizon.

The parameter k may be chosen as 3 or 4. This parameter may be tuned to achieve high performance of the algorithm.

### The Clarke-Wright Algorithm

This is a well established procedure in Vehicle Routing. The algorithm starts with elementary routes that may be combined to create longer ones that are time-efficient.

Step 1. Elementary routes are created, in which a vehicle starts at the BSB (denoted β), visits a broken Stryker i and returns back to the BSB. So, for each broken Stryker i, the algorithm creates the route {β, i, β}. The total number of routes equals the number of broken Strykers, which typically exceeds the number of vehicles available. Thus, these routes may need to be combined to produce one route per vehicle. This is done in the following step.

Step 2. Routes may be combined recursively, as follows: Examine together a route that includes broken Stryker i as a last stop before returning to the BSB, {β, . . . , i, β,} and a route that includes broken Stryker j as a first stop after the BSB, {β, j, . . . , β,}. Let cᵢ and cⱼ be the time length of each route, respectively. Now consider the combined route {β, i, j, . . . , β}, where the vehicle takes on the second route right after completing the first and skips the intermediate visit to the BSB.

Let cᵢⱼ be the length in time of this combined route. The time difference of the combined route versus the two single ones is cᵢ+cⱼ−cᵢⱼ. For every pair i and j of routes, the algorithm calculates the time difference of their possible combination, and combines the two routes with the largest difference. If there are ties, the algorithm chooses a pair at random. This combining may be repeated until the number of routes is equal to the number of vehicles.

### The Cluster-and-Route Algorithm

Another procedure to generate routes is to first create a cluster of broken Strykers for each truck and then create a route that includes all Strykers in the cluster, as in the Closest Neighbor Algorithm. Two clustering procedures have been implemented. Once visits to all Strykers in a cluster are scheduled, the algorithm may add additional stops to the route, such as the BSB or a company where the vehicle can pick up spare parts.

For example, in the experiments conducted by the inventors, it was observed that the number of possible routes generated with the three methods typically varies between 700 and 1000. One example optimized by the inventors deals with a 72-hour horizon, 36 types of parts, 7 repair trucks, 8 battalions, 19 companies and 147 broken Strykers. For this case, the inventors generated 1000 routes, from which 7 were chosen by the solution method described below.

### Solving the Integer Program with Fix-and-Resolve

To solve the Integer Program, its Linear Relaxation may be solved (e.g., the binary integer variables may be allowed to take fractional values and the resulting Linear Program may be solved), using, for example, the simplex method and the commercially available Constraint Logic Programming (CLP) solver. Then, the values of the relaxed binary variables xⱼ in the solution may be examined. Some of the variables will have value 0 or 1, which means the solution excludes (respectively, includes) them. Others will have values in between: for example, the solution may feature two routes for a vehicle, each with value 0.5. This indicates that the solution does not select one route over the other. Clearly, this is an inconclusive situation, which does not help us in selecting a route.

On the other hand, a route with value close to 1 suggests that this route can be part of an optimal solution. The inventors designed an iterative solution procedure around this, as follows:
The variables taking a fractional value close to 1 may be set to the value 1, thus ‘fixing’ them. However, if fixing a variable to the value 1 makes the linear program infeasible, then it is fixed to 0.
The size of the problem may be reduced by removing all the vehicles, inventory, and fixed Strykers associated with these routes.
The linear relaxation may be solved again, to optimize the smaller the problem.
The new variables close to 1 may be fixed and the process repeated, until there are no more variables taking a fractional value.

This procedure may be referred to as Fix and Resolve. The procedure is designed to produce a high-quality solution quickly (e.g., as more variables are fixed, the linear programs get smaller, and they are expected to solve faster.)

### Delivering All Spare Parts

The solution of the Integer Program may assign each vehicle to a repair route for broken Strykers, and may assign a load operation on the vehicle of each repair part required. Additional use can be made of this route to deliver, to the companies the spare parts specified by the Inventory Optimizer. The algorithm may include the following:
Companies that have parts to be delivered to them may be marked as ‘unfulfilled’.
A random ordering of the vehicles that are non-idle may be produced (e.g., the vehicles may have routes assigned to them).
For the next vehicle (going down the ordering):
   For each part the total quantity to be delivered to the companies on the route of the vehicle may be computed.
   It is examined whether the BSB (which is where the route starts) has these parts quantities available, either fully or partially.
   If the BSB has the parts quantities, the part may be loaded on the vehicle up to its capacity limit.
   As the vehicle travels its route and delivers parts to the companies, it is noted whether the parts delivered meet the total demand of each company or not. In the first case, the company may be marked as “fulfilled”.

At the end of this algorithm some companies may be unfulfilled (e.g., their demand will have been filled only partially, or not at all). For these companies, one or more vehicles may be reserved to run a special route: the vehicles may start from the BSB, tour the unfulfilled companies delivering parts and return to the BSB.

These vehicles may be scheduled using a closest-neighbor heuristic, as follows:
A route may be created for the vehicle, where the vehicle starts at the BSB, then visits the unfulfilled company closest to the BSB, then the unfulfilled company closest to this company, and so on. The last stop is the BSB.
For each company on the route, the quantity of parts needed to reach ‘fullfilled’ status may be calculated. A load plan for the vehicle is created, in which the vehicle loads the parts needed at the BSB. If the BSB cannot supply the full quantity needed, load operations may be added at companies that have excess inventory of the part needed and are visited earlier by the vehicle on the route. In all cases care should be taken not to exceed the capacity of the vehicle.

This heuristic is one of the methods available to create the tour. This tour scheduling problem is an instance of the Travelling Salesman problem in Operations Research. It is a well-studied problem and research has produced several high-quality heuristics to solve it. For the vehicle scheduling problem, the closest-neighbor heuristic outlined above should produce a good tour quickly.

### The Local Search Algorithm

In contrast to the Integer Programming algorithm, the Local Search algorithm may address both terms of the objective function simultaneously.

### The Local Search Technique

The Local Search Technique is a well-known method that has been used to solve many problems in scheduling, digital circuit design, and other areas. The general idea for a Local Search algorithm is to start with a feasible schedule and improve it in small (local) steps until one of two conditions is reached: 1) no further improvement can be found; or 2) a specified time limit expires.

At each step, an effort is made to improve the scheduling of trucks for Stryker repair, as well as the overall distribution of spare parts. This may be done by exploring the “neighborhood” of the current solution, and replacing it with another, better solution in the neighborhood. Solutions in the neighborhood are evaluated according to the objective function (Equation (2)). The process stops if a local optimum is reached (e.g., a schedule that cannot be improved by local improvement steps).

To define precisely a Local Search algorithm, it is important to specify how to find a feasible schedule (the starting point) and how to define the search neighborhood (e.g., the candidates for an improvement step).

In choosing the size of the neighborhood, two opposing objectives may be balanced:
Since the current schedule should be improved, the neighborhood must be large and varied enough to contain a good improvement.
Since a lot of time can not be spent exploring a neighborhood, the neighborhood must be small enough.

There are also several options in choosing an improvement in a neighborhood: one could take the best solution in the neighborhood, or one could take the first solution better then the current one. The second option decreases the running time of an iteration, but may also decrease the magnitude of the improvement.

### The Algorithm

### Initialization

The starting point could be any of the following three options:
The schedule generated by the Integer Programming algorithm, obtained by the algorithms described above in Solving the Integer Program with Fix-and-Resolve and Delivering All Spare Parts.
A schedule produced by any other algorithm, possibly designed specifically to serve as a starting point for Local Search.
No schedule at all.

In the first option, motivation is provided by the fact that the Integer Programming method does not generate all possible routes, just a small, manageable subset of good ones. It is possible, at least in theory, that better routes may exist, and the local search method may be used to improve upon the routes produced by Integer Programming (IP). Sometimes an improvement that is relatively small in terms of the objective function, but obvious to the human eye, may be missed by the IP solution's global viewpoint, and a local search can find this.

In the inventors' experiments, the second option was implemented, which itself is a variation on Local Search. First, the list of all needed repairs and corresponding loads and unloads of parts is created. These load and unload commands are added to the plan one by one.

For each one, a good place is found using the Local Search algorithm. Thus, the initial plan is optimized as it is being built. This improves the overall performance of Local Search significantly compared to starting with no schedule, because Local Search is faster when there are fewer commands in the plan and because the pre-optimized initial plan requires fewer improvement steps to reach a locally optimal state. (It should be noted that a Sophisticated Greedy Algorithm could be used as a possible starting point).

### Improvement Steps

The set of feasible improvements explored by the inventors include:

1. Insert a previously unscheduled repair or inventory replenishment order into one of the existing routes.

2. Perform a simple delete-and-reinsert swap, as follows:
a. Pick a route, a location in it, and the corresponding delete or repair operation at this location.
b. Delete the corresponding load operation in this route.
C. Insert the repair/unload operation into a different position at the same route, or insert it in some other route.
d. For the repair/unload operation inserted in a route at the last step, examine the route up to that operation, to find a location and time to insert the corresponding load operation.
e. Add the load operation to the route.

3. In case the algorithm cannot accommodate unscheduled orders and insert them into a current schedule, delete one of the scheduled orders and insert one of the unscheduled ones. Although this action may seem not to make progress, it may improve overall availability, as it may repair a broken Stryker sooner or repair a higher-priority broken Stryker.

### A Sophisticated Greedy Algorithm

A third transportation scheduling algorithm can be thought of as a sophisticated improvement on a natural greedy strategy.

When scheduling the pre-placement of spares according to the outputs of the Inventory Optimizer, the algorithm may work at the battalion level rather than at the company level, and may rely on automatic cross-leveling as needed between companies within a battalion.

The algorithm may include three main phases: oscillation avoidance, allocation of CRTs to battalions, and routing of individual CRTs.

In the first phase, the schedules from the previous time period for each of the CRTs may be considered. If a CRT has parts on board and its schedule will allow it to fix at least one Stryker before returning to BSB, it becomes a candidate for keeping its old schedule. Then some number of these candidate CRTs may be chosen in order of the first time at which the schedule fixes some Stryker.

For example, if there are 4 or more CRTs in total, 2 may be chosen. If there are 2 or 3 in total, only 1 may be chosen. If there is only 1 CRT, this phase may be skipped. The CRTs thus chosen may retain their schedules from the previous iteration, rather than getting assigned new schedules in phase 3.

A purpose of the first phase may be to ensure that progress is made (i.e., some Stryker gets fixed), and that CRTs are not continually rerouted without ever actually fixing any broken Strykers. These CRTs may be assigned to the battalion (or battalion-level unit; henceforth “battalion” will be used) which owns the first Stryker to be fixed, where the meaning of “assigned” will become clear shortly.

In the second phase, free CRTs may be assigned to free battalions, giving more weight to high priority ones and ones with many broken Strykers. (Note this is more flexible than the baseline in that more than one CRT may be assigned to the same battalion, or one CRT may be shared by more than one battalion.). More precisely, battalions may be ordered according to the priority factor (e.g., 1 for normal, 1.25 for battalions assigned priority by the OPLAN, multiplied by the number of broken Strykers in the battalion).

Strykers may then be assigned to battalions in round-robin fashion according to this ordering. However, the CRTs chosen in phase 1 to retain their previous schedules may be counted against the battalions to which the CRTs are assigned in that phase.

In the third phase, the actual schedules to be executed by the CRTs may be determined. A simplified form of results from Inventory Optimizer, namely a snapshot of the recommended inventory levels at 24 hours in the future, may be used to give a target inventory for each battalion. Then, for each battalion, the set of CRTs assigned in the previous phases may be scheduled to repair Strykers and deliver spare parts to the battalion. This may be performed as follows:

1) If the CRT has many parts on-board which can fix broken Strykers within its assigned battalion, it may not be scheduled to return to the BSB. The value of “many” that was chosen in the inventors' experiments was the number of broken Strykers that can be fixed by this CRT, divided by the total number of broken Strykers in the battalion. In other words, if this CRT can fix its share of broken Strykers with parts already on board, it may not sent back to the BSB for more parts.

2) If a CRT is scheduled to return to the BSB, the CRT may first load as many parts as possible to fix broken Strykers in its assigned battalion. The CRT may then load as many spare parts for the battalion as possible, up to the suggested inventory levels.

3) Next, for each CRT whether first directed to the BSB or not, broken Strykers may be added to the CRT's itinerary on a greedy basis (e.g., the nearest Stryker for which it has a part is fixed, then moves on the nearest Stryker to that location, and so on). Finally, it may move to the locations of the companies, in the same greedy fashion, to unload pre-positioned spares.

### Combining the Algorithms into a Continual Optimization Solution

The three algorithms described above in the previous sections may be combined into a single Transportation Scheduling Optimizer as follows: On each receipt of new data (typically three-hour granularity is used, but experiments were carried out with values as low as one hour and as 24 hours), all three algorithms may be run in parallel. Each one produces its own schedule. The quality of these schedules may be evaluated using the combined objective function (Equation (2)) over the full 72-hour planning horizon. The best schedule may be chosen according to the objective function (Equation (2)), the first portion of it may be returned to the simulator. The first portion may be executed, and the process repeats. The previous schedule may be discarded and a new schedule may be derived using the updated snapshot of the situation.

As stated above, this may be referred to as Continual Optimization. For example, the method of the exemplary aspects of the present invention may be re-optimized at fine granularity, and may continually incorporate the latest available data into the solution. The 72-hour horizon may be used to find the best plan, assuming nothing changes, at each time increment. If new data becomes available at the next time increment, a better solution for the new situation may be possible.

There are several benefits derived from using multiple algorithms. The first is high solution quality: The best of three available solutions may be chosen. Different algorithms may have better success in different situations. Because the method is optimized at a fine granularity, the best of all algorithms' performance may be obtained rather than having to always use a single algorithm's solution.

Another benefit is robustness. The likelihood of all three algorithms failing or producing low quality solutions is extremely small. Thus, the method according to the exemplary aspects of the present invention is almost certain to have a solution, and in fact a high quality one, at every time period.

### Experimental Results

The inventors carried out over 700 experiments using the Inventory and Transportation Optimizers. These experiments used a baseline 30-day scenario along with various combinations of stressors such as increased breakage rates, inventory losses, and road closures. The results of the optimization models in these experiments are summarized below.

### Running Time Performance

In production-level testing, the running time of the Inventory Optimizer was always less than 1 second. FIG. 7 provides Tables 1 and 2 which illustrate some of the results of the experiments conducted by the inventors.

Specifically, Table 1 illustrates running time statistics (in seconds) for the three transportation Optimizer algorithms (e.g., the average and maximum running times of the three Transportation Optimizer algorithms). These are taken over all iterations of all experiments. Each running time data point refers to one invocation of the optimizer, where there are 240 invocations for a run of 720 hours at three-hour granularity, for instance. The overall minimum, maximum, and mean for each algorithm, and also the same statistics with the highest and lowest 5 of values removed, are shown. The inventors' method for measuring running times of the Local Search algorithm differed slightly and the inventors' have only upper bounds on its running times.

As can be seen from Table 1, the computational requirements of the algorithms are quite modest.

### Solution Quality Performance

It is noted that the present invention may significantly improve operational availability (Aₒ) over that achieved in a separately developed simulation of current U.S. Army operations.

For instance, on the unstressed baseline scenario, the present invention (e.g., Inventory and Transportation Optimizers) achieve Aₒ of 96, compared to 84 for current operations. To compare the solution quality performance of the three Transportation Optimizer algorithms, the inventors collected statistics on a set of 75300 iterations. Normalizing the objective function to a scale of 0 to 100, the average winning score was 89.6. The average gap between the best and worst of the three scores was 0.16. The maximum gap was 14.4. Differences of less than 0.01 were considered by the inventors to be insignificant; in these cases a tie was declared.

Table 2 in FIG. 7 includes the win tallies among the three Transportation Optimizer algorithms (e.g., Table 2 shows for each algorithm the number of iterations for which that algorithm's solution was best among the three (e.g., “wins”). It also shows the number of times an algorithm's score was greater than 0.48, or three times the average gap, better than the others' (e.g., “Big Wins”).

The most frequent outcome was that the three algorithms achieved the same score. Integer Programming is the most frequent winner, but no single algorithm dominates the others.

In short, the results indicate that Continual Optimization may have the potential to significantly improve logistics operations (e.g., U.S. Army logistics operations), and in particular to significantly increase Aₒ (e.g., Aₒ of combat vehicles). The very modest computational requirements suggest that problems of much larger scale can be solved by the state-of-the-art optimization techniques provided by the exemplary aspects of the present invention.

### An Exemplary Embodiment

FIG. 8 illustrates a system 800 which has been developed and utilized by the inventors, according to an exemplary aspect of the present invention. As illustrated in FIG. 8, the system 800 may include a server 810 which may forward an OPLAN to an inventory optimizer 820. The system 800 may also include a transportation optimizer 830 which may receive data from the inventory optimizer 820 and generate inventory transportation scheduling (ITS) data (e.g., transportation schedule, transportation repository checkpoints, and scenario data and parameter data) and forward the ITS data to the server 810 which may store the ITS data.

The server 810 may use Extensible Mark-up Language (XML) messaging to forward data (e.g., ITS data such as a logistics plan) to a simulator 840 via a network 850 (e.g., the Internet). The simulator 840 may use XML messaging to forward data (e.g., scenario data (e.g., full)) and transactions (e.g., incremental updates) to the server 810 via the network 850.

The Transportation Optimizer 830 may produce a transportation schedule for all CRTs in the brigade over a time period (e.g., over the next 72 hours). Inputs to the Transportation Optimizer 830 may include 1) an inventory optimization plan containing a list of which parts need to be delivered to which locations and at which times, 2) a list of broken Strykers and their positions, and 3) positions and inventories of BSB, companies, and CRTs.

The transportation schedule may determine schedules for CRTs to 1) pick up parts at supply points (BSB and companies), 2) deliver parts to Strykers that need repair and carry out those repairs requiring CRT presence, and 3) visit the BSB and companies to load and unload parts so that each company approaches the inventory levels determined by the Inventory Optimizer.

The transportation schedule may incorporate other operational constraints, including 1) delivery time windows, 2) capacity limits for all CRTs and inventory locations (BSB and companies), and 3) speed limits and road closures.

The Transportation Optimizer 830 may include (e.g., three major components may include) integer programming (IP), a local search and a “sophisticated greedy” algorithm. Thus, the Transportation Optimizer 830 may utilize multiple algorithms. This allows the invention to provide robustness—if one algorithm fails, others can serve as backups. Further, the algorithms (e.g., all of the algorithms) may be performed in parallel and the best solution chosen. Further, integer programming may tend to find very good solutions with respect to the global objective, but may miss relatively minor but obvious (to the human eye) improvements. Local search can make these improvements.

In addition, by using multiple algorithms, the “greedy” solution can serve as starting point for the other algorithms. Further, a current implementation may make use of the first two options.

In the exemplary aspect of the present invention, the Transportation Optimizer 830 may use an objective function combining 1) fixing current breakages to maximize operational availability (Aₒ); and 2) satisfying the inventory plan given by the Inventory Optimizer.

The present invention may make use various different objective functions. In an exemplary aspect of the present invention, the objective function may include the operational availability and inventory terms. The first term (e.g., operational availability) may measure the availability of Strykers over the 72 hour planning horizon, weighted by priority and transformed to promote balance across battalions (by a function to be described). The second term (e.g., inventory) may reward a schedule for approaching the recommended inventory levels at the logistics points (BSB and companies). Further, relative weights for the two terms can be determined by tuning parameters (e.g., how much weight should be given to immediate demand versus positioning inventory to meet future demand).

It should also be noted that the present invention is not limited to the scenarios described above, but may be implemented in other scenarios and with a much broader scope. For example, the present invention could be utilized by fault-tolerant and distributed operations. Consistency protocols can identify “leaders” to compute solutions involving all communicating elements in each network partition, and Continual Optimization techniques may allow the reconciliation of divergent solutions once connectivity is restored. Further, the present invention may be used for other parts and inventories (e.g., fuel, food and water, munitions, etc. as well as Class IX parts), and may be implemented as part of an end-to-end supply chain. That is, as noted above, the present invention is in no way limited to a military logistics scenario but may be used in any scenario for scheduling delivery of any good and/or service.

Referring again to the drawings, FIG. 9 illustrates a typical hardware configuration which may be used for implementing the computer system and method according to the exemplary aspects of the present invention. The configuration has preferably at least one processor or central processing unit (CPU) 911. The CPUs 911 are interconnected via a system bus 912 to a random access memory (RAM) 914, read-only memory (ROM) 916, input/output (I/O) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, and Intranet, a personal area network (PAN), etc., and a display adapter 936 for connecting the bus 912 to a display device 938 and/or printer 939. Further, an automated reader/scanner 941 may be included. Such readers/scanners are commercially available from many sources.

In addition to the system described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, including signal-bearing media tangibly embodying a program of machine-readable instructions executable by a digital data processor to perform the above method.

Such a method may be implemented, for example, by operating the CPU 911 to execute a sequence of machine-readable instructions. These instructions may reside in various types of signal bearing media.

Thus, this aspect of the present invention is directed to a programmed product, including signal-bearing media tangibly embodying a program of machine-readable instructions executable by a digital data processor incorporating the CPU 911 and hardware above, to perform the method of the invention.

This signal-bearing media may include, for example, a RAM contained within the CPU 911, as represented by the fast-access storage for example. Alternatively, the instructions may be contained in another signal-bearing media, such as a magnetic data storage diskette 1000 (FIG. 10), directly or indirectly accessible by the CPU 911.

Whether contained in the computer server/CPU 911, or elsewhere, the instructions may be stored on a variety of machine-readable data storage media, such as DASD storage (e.g, a conventional “hard drive” or a RAID array), magnetic tape, electronic read-only memory (e.g., ROM, EPROM, or EEPROM), an optical storage device (e.g., CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, complied from a language such as “C” etc.

With its unique and novel features, the present invention provides a method and system of scheduling delivery of at least one of goods and services which may effectively optimize a performance objective in a mobile network (e.g., an environment in which the locations of inventory supply and/or demand may vary).

It should be noted that the term “network” may include a logistics network, the term “goods” may include inventory, repair parts, etc., the term “delivery vehicle” may include a plurality of delivery vehicles, the term “non-immediate demand” may include a future demand, the term “method” may include a computer-implemented method, the term “performance objective” may include a plurality of performance objectives (e.g., metrics), and the term “mobile point” may include a mobile supply point (e.g., a location which may supply goods and/or services), mobile demand point (e.g., a location which may demand goods and/or services), etc.

In addition, the term “customer” may include an entity (e.g., person, organization, business, etc.) which may be physically located at mobile point and which may demand delivery of an item of goods and/or an item of services.

While the invention has been described in terms of one or more exemplary embodiments, those skilled in the art will recognize that the invention can be practiced with modification within the spirit and scope of the appended claims. Specifically, one of ordinary skill in the art will understand that the drawings herein are meant to be illustrative, and the design of the inventive assembly is not limited to that disclosed herein but may be modified within the spirit and scope of the present invention.

Further, Applicant's intent is to encompass the equivalents of all claim elements, and no amendment to any claim the present application should be construed as a disclaimer of any interest in or right to an equivalent of any element or feature of the amended claim.

What is claimed is:

1. A method of scheduling delivery of at least one of goods and services, comprising:
inputting a performance objective, and network data pertaining to a network of mobile points; and
generating a delivery schedule for a delivery vehicle to deliver said at least one of said goods and services.

2. The method of claim 1, wherein said network data comprises at least one of data pertaining to a plan of movements for said mobile points, data pertaining to said delivery vehicle and a list of services that said delivery vehicle can perform, a list of goods demanded by said mobile points, and a list of services demanded by said mobile points.

3. The method of claim 1, wherein said mobile points comprise at least one of a source point which is a source of said goods, a storage point for storing said goods, a service demand point which demands said services, and a demand point which demands said goods.

4. The method of claim 1, wherein said services delivered by said delivery vehicle comprise at least one of picking up parts, delivering parts, and carrying out repairs at a mobile demand point in said network of mobile points.

5. The method of claim 1, wherein said network data comprises at least one of a list of on-hand hand inventory for an item of said goods at a mobile point in said network of mobile points, a list of on-hand inventory for an item of said goods in said delivery vehicle, a list of demands for an item of said goods at a mobile point in said network of mobile points, and a list of demands for an item of said services at a mobile point in said network of mobile points.

6. The method of claim 1, wherein said performance objective comprises at least one of immediate demand satisfaction, operational availability, customer wait time, and off-the-shelf fill rate.

7. The method of claim 1, wherein said generating said delivery schedule comprises at least one of estimating non-immediate demand, creating a set of target pre-positioning levels for storing said goods at a mobile point in said network to service non-immediate demand, and balancing immediate demand of an item of said goods with target pre-positioning levels of said item of said goods to optimize an enterprise objective.

8. The method of claim 1, wherein said delivery schedule comprises a policy for optimizing said performance objective.

9. The method of claim 1, wherein said goods comprise at least one of service parts, production parts, and non-discrete parts.

10. The method of claim 1, wherein a time allotted for said delivery comprises a total time of non-negligible time-consuming activities required for said delivery before said delivery vehicle may move to a next demand point in said network.

11. The method of claim 1, wherein said performance objective comprises at least one of operational availability, customer wait time, and a target pre-positioned stocking level for an item of said goods.

12. The method of claim 1, wherein said delivery schedule comprises a schedule for meeting an immediate demand for said goods and services and replenishing pre-positioned supplies of said goods at said mobile points.

13. The method of claim 1, wherein said network of mobile points comprises a mobile demand point having a variable location, and a mobile inventory stocking point having a variable location.

14. The method of claim 1, wherein said generating said delivery schedule comprises using one of an integer and linear programming algorithm and a local improvement algorithm.

15. The method of claim 1, further comprising:
outputting said delivery schedule using at least one of a display device, audio device, and a printer.

16. The method of claim 1, wherein said generating said delivery schedule comprises using an algorithm for finding a shortest route from a point to a moving point in said network of moving points.

17. The method of claim 17, wherein said algorithm comprises an enhanced version of Dijkstra's algorithm.

18. A system for scheduling delivery of at least one of goods and services, comprising:
an input device for inputting a performance objective, and network data pertaining to a network of mobile points; and
a schedule generator for generating a delivery schedule for a delivery vehicle to deliver said at least one of said goods and services.

19. A programmable storage medium tangibly embodying a program of machine-readable instructions executable by a digital processing apparatus to perform a method of scheduling delivery of at least one of goods and services, said method comprising:
inputting a performance objective, and network data pertaining to a network of mobile points; and
generating a delivery schedule for a delivery vehicle to deliver said at least one of said goods and services.

20. The method of claim 1, further comprising:
deploying computing infrastructure in which computer-readable code is integrated into a computing system, such that said code and said computing system combine to perform said inputting said performance objective, and said network data pertaining to said network of mobile points, and said generating said delivery schedule for said delivery vehicle to deliver said at least one of said goods and services.
